(19) United States
(12) Patent Application Publication
(10) Pub. No.: US 2018/0072969 A1
(43) Pub. Date: Mar. 15, 2018

(54) ORGANIC DETERGENT POWDER AND SINGLE-DOSE COMPRESSED TABLETS THEREOF

(71) Applicant: GREENOLOGY PRODUCTS, INC., RALEIGH, NC (US)

(72) Inventors: ADAM MCCARTHY, RALEIGH, NC (US); DAVID ANDREW GORDON, LAFAYETTE, LA (US)

(73) Assignee: GREENOLOGY PRODUCTS, INC., RALEIGH, NC (US)

(21) Appl. No.: 15/264,982

(22) Filed: Sep. 14, 2016

(51) Int. Cl. C11D 3/382; C11D 3/50; C11D 3/22; C11D 3/386; C11D 3/04; C11D 3/12; C11D 3/20; C11D 3/33; C11D 3/30; C11D 3/10; C11D 3/384; C11D 3/39; C11D 17/00; C11D 17/06

(52) U.S. Cl. CPC C11D 3/382; C11D 3/38645; C11D 3/222; C11D 3/38609; C11D 3/046; C11D 3/044; C11D 3/1253; C11D 3/2086; C11D 3/33; C11D 3/30; C11D 3/10; C11D 3/384; C11D 3/3942; C11D 17/0047; C11D 17/06; C11D 3/50

(57) ABSTRACT

Organic detergent powder compositions and single-dose compressed tablets thereof are disclosed. The organic detergent powder composition can comprise one or more of the following ingredients: saponified oils, lyes, binders, fillers, carriers, disintegrants, inert ingredients, salts or water softeners, detergency aids, defoamers or flow agents, enzymes, chelating agents, and fragrances in amounts complying with the United States Department of Agriculture's (USDA's) National Organic Program (NOP) for products labeled as “organic” or “made with organic.” In some aspects, the organic detergent powder composition comprises organic soapberry powder and one or more of a salt, one or more detergency aids, one or more enzymes, and one or more fragrances.

### BACKGROUND

Liquid and liquid gel and/or compressed detergent powder compositions available in single-dose tablets or gel packs are seeing wider use among consumers for a variety of reasons of convenience. Consumers are attracted to such single-dose tablets or gel packs because they are less likely to result in spillage or dripping and the contents come in pre-measured volumes, making them easy to use. The contents of such tablets or gel packs, i.e., the detergent composition, can be toxic, however, if consumed by a human or animal. According to the American Association of Poison Control Centers (AAPCC), in the first six months of 2015 alone, poison-control centers nationwide received 6,046 reports of children aged five and younger ingesting or inhaling such single-dose tablets or gel packs or getting the tablet or gel pack contents on their skin or in their eyes.

Most commercial detergent formulations generally contain non-naturally occurring and/or non-organic components, including surfactants, bleaches, and other synthetic or manmade chemicals, many of which are toxic or damaging to the environment. Accordingly, there is a need for non-toxic, certified organic detergent compositions for use with single-dose detergent tablets or compressed in a dry powder or dry soap tablet, or as a combination of both compressed powder and soap formulations.

### SUMMARY

The presently disclosed subject matter provides certified organic detergent compositions for use with single-dose detergent tablets or compressed in a dry powder or dry soap tablet, or as a combination of both compressed powder and soap formulations. The presently disclosed organic detergent comprises naturally and/or organically occurring ingredients, provides effective detergent action, is generally safe(r) to use and less toxic to the user and the environment than existing detergent powder compositions, and complies with the requirements of the United States Department of Agriculture's (USDA's) National Organic Program (NOP) for products labeled as “organic” or “made with organic.”

In some aspects, the presently disclosed subject matter provides an organic detergent composition comprising from about 0.10% by weight to about 99% by weight saponified oil; from about 0.1% by weight to about 75% by weight of one or more of a binder, filler, carrier, disintegrant, and inert ingredient; from about 0.10% by weight to about 30% by weight of one or more detergency aids; and from about 0.1% by weight to about 7% by weight of one or more enzymes; wherein the composition comprises at least one of (i) not less than 95 percent organically produced raw or processed agricultural products, or (ii) at least 70 percent certified organic ingredients. In certain aspects, the composition is provided in a single-dose compressed tablet. In yet more certain aspects, the composition comprises a laundry detergent.

In other aspects, the presently disclosed subject matter provides an organic detergent composition comprising from about 0.10% by weight to about 99% weight saponified oil; from about 0.1% by weight to about 75% by weight of one or more of a binder, filler, carrier, disintegrant, and inert ingredient; from about 0.10% by weight to about 30% by weight of one or more detergency aids; from about 0.1% by weight to about 7% by weight of one or more enzymes; and from about 0.1% by weight to about 75% by weight salt or water softener; wherein the composition comprises at least one of (i) not less than 95 percent organically produced raw or processed agricultural products, or (ii) at least 70 percent certified organic ingredients. In certain aspects, the composition is provided in a single-dose compressed tablet. In yet more certain aspects, the composition comprises an automatic dishwashing detergent.

In yet other aspects, the presently disclosed subject matter provides an organic detergent composition comprising organic soapberry powder. In particular aspects, the composition comprises from about 0.1% by weight to about 98% by weight organic soapberry powder; from about 0.1% to about 35% salt; from about 0.1% by weight to about 5% by weight of one or more detergency aids; optionally from about 0.1% by weight to about 5% by weight of one or more enzymes; and optionally about 0.1% by weight to about 5% by weight of one or more fragrances. In certain aspects, the composition is provided in a single-dose compressed tablet. In yet more certain aspects, the composition comprises a laundry detergent.

Certain aspects of the presently disclosed subject matter having been stated hereinabove, which are addressed in whole or in part by the presently disclosed subject matter, other aspects will become evident as the description proceeds when taken in connection with the accompanying Examples as best described herein below.

### DETAILED DESCRIPTION

The presently disclosed subject matter now will be described more fully hereinafter with reference to the accompanying Examples, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Examples. Therefore, it is to be understood that the presently disclosed subject matter is not to be limited to the specific embodiments disclosed and that modifications and other embodiments are intended to be included within the scope of the appended claims.

### I. Organic Detergent Powder and Single-Dose Compressed Tablets Thereof

In some embodiments, the presently disclosed subject matter provides an organic detergent powder composition and single-dose compressed tablets thereof. Such tablets provide for accurate dosing while eliminating the need for the consumer to measure the composition or come into direct contact with the composition. Accordingly, tablets containing pre-measured detergent agents provide for convenience of consumer use in a variety of applications. A consumer can directly add the tablet to an appliance, such as an automatic dishwasher or washing machine, or other mixing vessel, such as a bucket or sink. Mixing containers and methods suitable for use in preparing concentrated liquid detergent compositions from the presently disclosed organic detergent powder are disclosed in U.S. Pat. Nos. 9,290,726 and 9,150,818, each of which is incorporated by reference in their entirety. There is a need, however, for non-toxic, organic detergent compositions for use with single-dose detergent tablets or as a dry powder.

The presently disclosed compositions comply with the “organic” and “made with organic” guidelines of the United States Department of Agriculture's National Organic Program (NOP), while exhibiting commercially acceptable detergent properties. As used herein, the term “commercially acceptable detergent properties” refers generally to the degree of cleanliness, extent of effort, or both that a typical consumer would expect to achieve or expend when using a detergent product to address a typical soiling condition on a typical substrate, e.g., dishes or laundry, including clothing. This degree of cleanliness may, depending on the particular product and particular substrate, correspond to a general absence of visible soiling, or to some lesser degree of cleanliness. Cleanliness may normally be determined using generally agreed industry standard tests or localized variations of such tests. In the absence of such agreed industry standard tests, cleanliness may be evaluated using the test or tests already employed by a manufacturer or seller to evaluate the cleaning performance of its cleaning products sold in association with its brand.

### A. Organic Laundry Detergent Comprising Saponified Oil

In some embodiments, the presently disclosed subject matter provides an organic laundry detergent composition comprising from about 0.10% by weight to about 99% by weight saponified oil; from about 0.1% by weight to about 75% by weight of one or more of a binder, filler, carrier, disintegrant, and inert ingredient; from about 0.10% by weight to about 30% by weight of one or more detergency aids; and from about 0.1% by weight to about 7% by weight of one or more enzymes; wherein the composition comprises at least one of (i) not less than 95 percent organically produced raw or processed agricultural products, or (ii) at least 70 percent certified organic ingredients.

In particular embodiments, the composition comprises from about 10% by weight to about 70% by weight saponified oil; from about 10% by weight to about 65% by weight of one or more of a binder, filler, carrier, disintegrant, and inert ingredient; from about 5% by weight to about 35% by weight of one or more detergency aids; and from about 0.5% by weight to about 5% by weight of one or more enzymes.

In yet other embodiments, the composition comprises from about 30% by weight to about 50% by weight saponified oil; from about 30% by weight to about 45% by weight of one or more of a binder, filler, carrier, disintegrant, and inert ingredient; from about 15% by weight to about 25% by weight of one or more detergency aids; and from about 1% by weight to about 3% by weight of one or more enzymes.

In particular embodiments, the saponified oil is selected from the group consisting of, but not limited to, NOP certified or NOP allowable coconut oil, palm (kernel or fruit) oil, corn oil, olive oil, soybean oil, sunflower oil, safflower oil, hemp oil, babassu oil, evening primrose oil, almond oil, apricot kernel oil, avocado oil, canola oil, castor oil, cocoa butter, cottonseed oil, emu oil, grapeseed oil, jojoba oil, lanolin, meadowfoam oil, lard, neem oil, shea butter, tallow, rapeseed oil, glycerin, peanut oil, vegetable oil, sesame oil, lemon oil, orange oil, grapefruit seed oil, and combinations thereof. In particular embodiments, the presently disclosed organic detergent powder comprises from about 0.10% by weight to about 99% weight saponified oil, including about 0.10%, about 0.5%, about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 96%, about 97%, about 98%, and about 99% by weight saponified oil, and any integer percentage and fraction thereof depending on product function.

In particular embodiments, the one or more of a binder, filler, carrier, disintegrant, and inert ingredient is selected from the group consisting of, but not limited to, NOP certified or NOP allowable alginate, agar-agar, carrageenan, gellan gum, gum Arabic, cellulose and its derivatives including, but not limited to, carboxymethyl cellulose (CMC), hydroxypropylmethylcellulose (HPMC), and methyl cellulose, gelatin, synthetic polymers (e.g., poly(vinylpyrrolidinone) (PVP), poly(ethylene glycol) (PEG)), guar gum, gum acacia, xanthan gum, locust bean gum, potato starch, rice starch, wheat starch, cassava starch, barley starch, oat starch, sorghum starch, sweet potato starch, rye starch, bean starch, bentonite, attapulgite, carnauba wax, wood resin, kaolin, corn starch, maltodextrin, dextrose, waxy maize starch, sugar alcohols, lecithin (soy or other), tapioca starch, sorbitol, soap berry or soap berry bark powder, and combinations thereof. In particular embodiments, the presently disclosed organic detergent powder comprises from about 0.1% by weight to about 75% by weight of one or more of a binder, filler, carrier, disintegrant, and inert ingredient, including about 0.10%, about 0.5%, about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, and about 75% by weight of one or more of a binder, filler, carrier, disintegrant, and inert ingredient, and any integer percentage and fraction thereof depending on product function.

As used herein, a “disintegrant” is an agent added to a tablet or formulation to promote the breakup of the tablet contents into smaller fragments in an aqueous environment, thereby increasing the available surface area and promoting a more rapid release of the active ingredient.

In particular embodiments, the one or more detergency aids are selected from the group consisting of, but not limited to, NOP certified or NOP allowable calcium carbonate, calcium sulfate, magnesium sulfate, magnesium chloride, magnesium carbonate, magnesium stearate, potassium iodide, sodium carbonate, sodium percarbonate, sodium bicarbonate, calcium citrate; potassium acid tartrate, potassium carbonate, potassium citrate, sodium citrate, potassium bicarbonate, sodium perborate, sodium gluconate, and combinations thereof. In particular embodiments, the presently disclosed organic detergent powder comprises from about 0.10% by weight to about 30% by weight of one or more detergency aids, including about 0.1%, about 0.5%, about 1.0%, about 2%, about 3%, about 4%, about 5%, about 10%, about 15%, about 20%, about 25%, and about 30% by weight one or more detergency aids, and any integer percentage and fraction thereof depending on product function.

In particular embodiments, the one or more enzymes are selected from the group consisting of, but not limited to, NOP certified or NOP allowable protease (Subtilisin), amylase, cellulose, lipase, mannanase, natalase, pectinase, termamyl, xyloglucanase, and the like, and combinations thereof. In particular embodiments, the presently disclosed organic detergent powder comprises from about 0.10% by weight to about 30% by weight of one or more enzymes, including about 0.1%, about 0.5%, about 1.0%, about 2%, about 3%, about 4%, about 5%, and about 7% by weight one or more enzymes, and any integer percentage and fraction thereof depending on product function.

In some embodiments, the presently disclosed composition comprises one or more fragrances. In particular embodiments, the one or more fragrances are selected from the group consisting of, but not limited to, NOP certified or NOP allowable fragrance (organic, natural, or synthetic), and essential oils. In particular embodiments, the presently disclosed organic detergent powder comprises from about 0.10% by weight to about 5% by weight of one or more fragrances, including about 0.1%, about 0.5%, about 1.0%, about 2%, about 3%, about 4%, and about 5% by weight one or more fragrances, and any integer percentage and fraction thereof depending on product function. In particular embodiments, the fragrance is a natural fragrance that is phthalate free.

Essential oils can be used for fragrancing, cleaning properties, preservation, soil penetration, saponification, and therapeutic benefits. Representative essential oil include, but are not limited to, NOP certified or NOP allowable allspice, ambrette seed, amyris, angelica root, anise, star anise, atlas cedarwood, Peru balsam, basil, holy basil, bay, bay laurel, beeswax absolute, benzoin absolute, bergamot, bergamot mint, black pepper, blue cypress, bois-de-rose, boronia, bursera graveolens, cajeput, cananga, cardamom, carrot seed, cassia, catnip/catmint, atlas cedarwood, Virginian cedarwood, German chamomile, Roman chamomile, chocolate peppermint, cinnamon, citronella, clary sage, clove bud, coffee, common sage, coriander, cumin, cypress, blue cypress, davana, dill, dalmation sage, elemi, eucalyptus, lemon eucalyptus, radiata eucalyptus, fennel, fir needle, frankincense, galbanum, geranium, rose geranium, ginger, grapefruit, gurjum balsam, helichrysum, hyssop, immortelle, jamine absolute, juniper berry, kanuka, abrialis lavandula, lavender, lavendin, lemon, lemon balm, lemon eucalyptus, lemongrass, lemon myrtle, lime, linden blossom, mandarin, mandravasarotra, manuka, marjoram, may Chang, melissa, mullein, myrrh, myrtle, lemon myrtle, neroli, niaouli, nutmeg, oakmoss, oliganum, bitter orange, sweet orange, oregano, palmarosa, palo santo, parsley, patchouli, peppermint, petitgrain, berry/leaf pimento, scotch pine, ravensara, rose, rosemary, rosewood, common sage, Spanish sage, sandalwood, saro, spearmint, spikenard, spruce, tagetes, tangerine, common tea tree, lemon tea tree, New Zealand tea tree, thyme, tobacco, tuberose, tulsi, vanilla, vetiver, violet leaf, yarrow, ylang ylang, and yuzu.

In some embodiments, the presently disclosed composition comprises one or more lye ingredients. In particular embodiments, the lye is selected from the group consisting of, but not limited to, NOP certified or NOP allowable sodium hydroxide, potassium hydroxide, calcium hydroxide, and combinations thereof. In particular embodiments, the presently disclosed organic detergent powder comprises from about 0.1% by weight to about 30% by weight lye, including about 0.1%, about 0.5%, about 1.0%, about 2%, about 3%, about 4%, about 5%, about 10%, about 15%, about 20%, about 25%, and about 30% by weight lye, and any integer percentage and fraction thereof depending on product function.

In some embodiments, the presently disclosed composition comprises a salt or water softener. In particular embodiments, the salt or water softener is selected from the group consisting of, NOP certified or NOP allowable but not limited to, sodium chloride, potassium chloride, calcium chloride, sea salt, table salt, celery salt, curing salt, dairy salt flake salt, fleur de sel, garlic salt, kosher salt, Himalayan salt, jukyeom, kala namak, LoSalt (66% potassium chloride/33% sodium chloride), pickling salt, truffle salt, and combinations thereof. In particular embodiments, the presently disclosed organic detergent powder comprises from about 0.1% by weight to about 75% by weight salt or water softener; including about 0.10%, about 0.5%, about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, and about 75% by weight of salt or water softener, and any integer percentage and fraction thereof depending on product function.

In yet other embodiments, the salt is selected from the group consisting of a fatty acid salt, sodium carbonate, sodium sulfate, sodium bicarbonate, sodium citrate, sodium hydroxide, potassium hydroxide, magnesium sulfate (e.g., Epsom salt), and combinations thereof.

In some embodiments, the presently disclosed composition includes one or more defoamers or flow agents. As used herein, the term “defoamer” includes both anti-foam agents that prevent or reduce foam formation or defoaming agents that break down foam once it is formed in detergent formulations. In particular embodiments, the one or more defoamers are selected from the group consisting of, but not limited to, NOP certified or NOP allowable silica, sodium silicate and its derivatives, talc, bentonite, and combinations thereof. In particular embodiments, the presently disclosed organic detergent powder comprises from about 0.10% by weight to about 30% by weight of one or more defoamers, including about 0.1%, about 0.5%, about 1.0%, about 2%, about 3%, about 4%, about 5%, about 10%, about 15%, about 20%, about 25%, and about 30% by weight one or more defoamers, and any integer percentage and fraction thereof depending on product function.

As used herein, the term “flow agent” refers to any material that increases the flow of a dry powder. In particular embodiments, the flow agent is selected from the group consisting of cellulose gum, carboxymethyl cellulose/carboxymethyl hydroxyethyl cellulose (CMC/CMHEC), guar gum, gellan gum, bovine bone gelatin, acacia gum, xanthan gum, cassia gum, hydroxy ethyl cellulose, glycerin, sodium carboxymethyl cellulose, and modified starch.

In some embodiments, the presently disclosed organic detergent powder composition comprises a flow agent in an amount ranging from about 0.10% by weight to about 30% by weight of one or more flow agents, including about 0.1%, about 0.5%, about 1.0%, about 2%, about 3%, about 4%, about 5%, about 10%, about 15%, about 20%, about 25%, and about 30% by weight one or more flow agents, and any integer percentage and fraction thereof depending on product function.

In yet other embodiments, the presently disclosed organic detergent powder can include one or more of a surfactant, a polymer, a brightener, a natural surfactant, one or more additional acids, one or more alcohols, and combinations thereof.

In other embodiments, the presently disclosed organic detergent powder can include one or more bleaching agents. In particular embodiments, the bleaching agent can include, but is not limited to, NOP certified or NOP allowable sodium hypochlorite, calcium hypochlorite, hydrogen peroxide, and one or more peroxygen compounds, and combinations thereof.

In particular embodiments, the presently disclosed composition comprises a laundry detergent. The presently disclosed organic detergent powder can be pressed into a single-dose tablet by direct compression or also can be provided in a loose powder form. Tablets comprising the presently disclosed organic detergent powder composition can be made using any suitable equipment and method. The molds, in which tablets can be made, can have any shape, length, width and depth, depending on the required dimensions of the tablets. In further embodiments, consumer packaging of the presently disclosed composition can include silica gel or other absorbent for absorbing moisture.

### B. Organic Automated Dishwashing Detergent Comprising Saponified Oil

In some embodiments, the presently disclosed subject matter provides an organic automated dishwashing detergent composition comprising from about 0.10% by weight to about 99% weight saponified oil; from about 0.1% by weight to about 75% by weight of one or more of a binder, filler, carrier, disintegrant, and inert ingredient; from about 0.10% by weight to about 30% by weight of one or more detergency aids; from about 0.1% by weight to about 7% by weight of one or more enzymes; and from about 0.1% by weight to about 75% by weight salt or water softener; wherein the composition comprises at least one of (i) not less than 95 percent organically produced raw or processed agricultural products, or (ii) at least 70 percent certified organic ingredients.

In particular embodiments, the composition comprises from about 5% by weight to about 45% weight saponified oil; from about 15% by weight to about 75% by weight of one or more of a binder, filler, carrier, disintegrant, and inert ingredient; from about 0.5% by weight to about 35% by weight of one or more detergency aids; from about 0.5% by weight to about 5% by weight of one or more enzymes; and from about 0.5% by weight to about 5% by weight salt or water softener.

In yet more particular embodiments, the composition comprises from about 15% by weight to about 35% weight saponified oil; from about 35% by weight to about 65% by weight of one or more of a binder, filler, carrier, disintegrant, and inert ingredient; from about 15% by weight to about 25% by weight of one or more detergency aids; from about 2% by weight to about 4% by weight of one or more enzymes; and from about 1% by weight to about 3% by weight salt or water softener.

In particular embodiments, the saponified oil is selected from the group consisting of, but not limited to, NOP certified or NOP allowable coconut oil, palm (kernel or fruit) oil, corn oil, olive oil, soybean oil, sunflower oil, safflower oil, hemp oil, babassu oil, evening primrose oil, almond oil, apricot kernel oil, avocado oil, canola oil, castor oil, cocoa butter, cottonseed oil, emu oil, grapeseed oil, jojoba oil, lanolin, meadowfoam oil, lard, neem oil, shea butter, tallow, rapeseed oil, glycerin, peanut oil, vegetable oil, sesame oil, lemon oil, orange oil, grapefruit seed oil, and combinations thereof. In particular embodiments, the presently disclosed organic detergent powder comprises from about 0.10% by weight to about 99% weight saponified oil, including about 0.10%, about 0.5%, about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 96%, about 97%, about 98%, and about 99% by weight saponified oil, and any integer percentage and fraction thereof depending on product function.

In particular embodiments, the one or more of a binder, filler, carrier, disintegrant, and inert ingredient is selected from the group consisting of, but not limited to, NOP certified or NOP allowable alginate, agar-agar, carrageenan, gellan gum, gum Arabic, cellulose and its derivatives including, but not limited to, carboxymethyl cellulose (CMC), hydroxypropylmethylcellulose (HPMC), and methyl cellulose, gelatin, synthetic polymers (e.g., poly(vinylpyrrolidinone) (PVP), poly(ethylene glycol) (PEG)), guar gum, gum acacia, xanthan gum, locust bean gum, potato starch, rice starch, wheat starch, cassava starch, barley starch, oat starch, sorghum starch, sweet potato starch, rye starch, bean starch, bentonite, attapulgite, carnauba wax, wood resin, kaolin, corn starch, maltodextrin, dextrose, waxy maize starch, sugar alcohols, lecithin (soy or other), tapioca starch, sorbitol, soap berry or soap berry bark powder, and combinations thereof. In particular embodiments, the presently disclosed organic detergent powder comprises from about 0.1% by weight to about 75% by weight of one or more of a binder, filler, carrier, disintegrant, and inert ingredient, including about 0.10%, about 0.5%, about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, and about 75% by weight of one or more of a binder, filler, carrier, disintegrant, and inert ingredient, and any integer percentage and fraction thereof depending on product function.

In particular embodiments, the one or more detergency aids are selected from the group consisting of, but not limited to, NOP certified or NOP allowable calcium carbonate, calcium sulfate, magnesium sulfate, magnesium chloride, magnesium carbonate, magnesium stearate, potassium iodide, sodium carbonate, sodium percarbonate, sodium bicarbonate, calcium citrate; potassium acid tartrate, potassium carbonate, potassium citrate, sodium citrate, potassium bicarbonate, sodium perborate, sodium gluconate, and combinations thereof. In particular embodiments, the presently disclosed organic detergent powder comprises from about 0.10% by weight to about 30% by weight of one or more detergency aids, including about 0.1%, about 0.5%, about 1.0%, about 2%, about 3%, about 4%, about 5%, about 10%, about 15%, about 20%, about 25%, and about 30% by weight one or more detergency aids, and any integer percentage and fraction thereof depending on product function.

In particular embodiments, the one or more enzymes are selected from the group consisting of, but not limited to, NOP certified or NOP allowable protease (Subtilisin), amylase, cellulose, lipase, mannanase, natalase, pectinase, termamyl, xyloglucanase, and the like, and combinations thereof. In particular embodiments, the presently disclosed organic detergent powder comprises from about 0.10% by weight to about 30% by weight of one or more enzymes, including about 0.1%, about 0.5%, about 1.0%, about 2%, about 3%, about 4%, about 5%, and about 7% by weight one or more enzymes, and any integer percentage and fraction thereof depending on product function.

In particular embodiments, the salt or water softener is selected from the group consisting of, but not limited to, NOP certified or NOP allowable sodium chloride, potassium chloride, calcium chloride, sea salt, table salt, celery salt, curing salt, dairy salt flake salt, fleur de sel, garlic salt, kosher salt, Himalayan salt, jukyeom, kala namak, LoSalt (66% potassium chloride/33% sodium chloride), pickling salt, truffle salt, and combinations thereof. In particular embodiments, the presently disclosed organic detergent powder comprises from about 0.1% by weight to about 75% by weight salt or water softener; including about 0.10%, about 0.5%, about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, and about 75% by weight of salt or water softener, and any integer percentage and fraction thereof depending on product function.

In yet other embodiments, the salt is selected from the group consisting of a fatty acid salt, sodium carbonate, sodium sulfate, sodium bicarbonate, sodium citrate, sodium hydroxide, potassium hydroxide, magnesium sulfate (e.g., Epsom salt), and combinations thereof.

In some embodiments, the presently disclosed composition comprises one or more fragrances. In particular embodiments, the one or more fragrances are selected from the group consisting of, but not limited to, NOP certified or NOP allowable fragrance (organic, natural, or synthetic), and essential oils. In particular embodiments, the presently disclosed organic detergent powder comprises from about 0.10% by weight to about 5% by weight of one or more fragrances, including about 0.1%, about 0.5%, about 1.0%, about 2%, about 3%, about 4%, and about 5% by weight one or more fragrances, and any integer percentage and fraction thereof depending on product function. In particular embodiments, the fragrance is a natural fragrance that is phthalate free.

Essential oils can be used for fragrancing, cleaning properties, preservation, soil penetration, saponification, and therapeutic benefits. Representative essential oil include, but are not limited to, NOP certified or NOP allowable allspice, ambrette seed, amyris, angelica root, anise, star anise, atlas cedarwood, Peru balsam, basil, holy basil, bay, bay laurel, beeswax absolute, benzoin absolute, bergamot, bergamot mint, black pepper, blue cypress, bois-de-rose, boronia, bursera graveolens, cajeput, cananga, cardamom, carrot seed, cassia, catnip/catmint, atlas cedarwood, Virginian cedarwood, German chamomile, Roman chamomile, chocolate peppermint, cinnamon, citronella, clary sage, clove bud, coffee, common sage, coriander, cumin, cypress, blue cypress, davana, dill, dalmation sage, elemi, eucalyptus, lemon eucalyptus, radiata eucalyptus, fennel, fir needle, frankincense, galbanum, geranium, rose geranium, ginger, grapefruit, gurjum balsam, helichrysum, hyssop, immortelle, jamine absolute, juniper berry, kanuka, abrialis lavandula, lavender, lavendin, lemon, lemon balm, lemon eucalyptus, lemongrass, lemon myrtle, lime, linden blossom, mandarin, mandravasarotra, manuka, marjoram, may Chang, melissa, mullein, myrrh, myrtle, lemon myrtle, neroli, niaouli, nutmeg, oakmoss, oliganum, bitter orange, sweet orange, oregano, palmarosa, palo santo, parsley, patchouli, peppermint, petitgrain, berry/leaf pimento, scotch pine, ravensara, rose, rosemary, rosewood, common sage, Spanish sage, sandalwood, saro, spearmint, spikenard, spruce, tagetes, tangerine, common tea tree, lemon tea tree, New Zealand tea tree, thyme, tobacco, tuberose, tulsi, vanilla, vetiver, violet leaf, yarrow, ylang ylang, and yuzu.

In some embodiments, the presently disclosed composition comprises one or more lye ingredients. In particular embodiments, the lye is selected from the group consisting of, but not limited to, NOP certified or NOP allowable sodium hydroxide, potassium hydroxide, calcium hydroxide, and combinations thereof. In particular embodiments, the presently disclosed organic detergent powder comprises from about 0.1% by weight to about 30% by weight lye, including about 0.1%, about 0.5%, about 1.0%, about 2%, about 3%, about 4%, about 5%, about 10%, about 15%, about 20%, about 25%, and about 30% by weight lye, and any integer percentage and fraction thereof depending on product function.

In some embodiments, the presently disclosed composition comprises a salt or water softener. In particular embodiments, the salt or water softener is selected from the group consisting of, but not limited to, NOP certified or NOP allowable sodium chloride, potassium chloride, calcium chloride, sea salt, table salt, celery salt, curing salt, dairy salt flake salt, fleur de sel, garlic salt, kosher salt, Himalayan salt, jukyeom, kala namak, LoSalt (66% potassium chloride/33% sodium chloride), pickling salt, truffle salt, and combinations thereof. In particular embodiments, the presently disclosed organic detergent powder comprises from about 0.1% by weight to about 75% by weight salt or water softener; including about 0.10%, about 0.5%, about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, and about 75% by weight of salt or water softener, and any integer percentage and fraction thereof depending on product function.

In yet other embodiments, the salt is selected from the group consisting of a fatty acid salt, sodium carbonate, sodium sulfate, sodium bicarbonate, sodium citrate, sodium hydroxide, potassium hydroxide, magnesium sulfate (e.g., Epsom salt), and combinations thereof.

In some embodiments, the presently disclosed composition includes one or more defoamers or flow agents. In particular embodiments, the one or more defoamers are selected from the group consisting of, but not limited to, NOP certified or NOP allowable silica, sodium silicate and its derivatives, talc, bentonite, and combinations thereof. In particular embodiments, the presently disclosed organic detergent powder comprises from about 0.10% by weight to about 30% by weight of one or more defoamers, including about 0.1%, about 0.5%, about 1.0%, about 2%, about 3%, about 4%, about 5%, about 10%, about 15%, about 20%, about 25%, and about 30% by weight one or more defoamers, and any integer percentage and fraction thereof depending on product function.

In some embodiments, the presently disclosed organic detergent powder composition comprises a flow agent in an amount ranging from about 0.10% by weight to about 30% by weight of one or more flow agents, including about 0.1%, about 0.5%, about 1.0%, about 2%, about 3%, about 4%, about 5%, about 10%, about 15%, about 20%, about 25%, and about 30% by weight one or more flow agents, and any integer percentage and fraction thereof depending on product function.

In yet other embodiments, the presently disclosed organic detergent powder can include one or more of a surfactant, a polymer, a brightener, a natural surfactant, one or more additional acids, one or more alcohols, and combinations thereof.

In other embodiments, the presently disclosed organic detergent powder can include one or more bleaching agents. In particular embodiments, the bleaching agent can include, but is not limited to, NOP certified or NOP allowable sodium hypochlorite, calcium hypochlorite, hydrogen peroxide, and one or more peroxygen compounds, and combinations thereof.

In particular embodiments, the presently disclosed composition comprises an automatic dishwashing detergent. The presently disclosed organic detergent powder can be pressed into a single-dose tablet by direct compression or also can be provided in a loose powder form. Tablets comprising the presently disclosed organic detergent powder composition can be made using any suitable equipment and method. The molds, in which tablets can be made, can have any shape, length, width and depth, depending on the required dimensions of the tablets. In further embodiments, consumer packaging of the presently disclosed composition can include silica gel or other absorbent for absorbing moisture.

### C. Organic Detergent Powder Comprising Organic Soapberry Powder

Soapberries, also referred to as “soapnuts” are the fruit of shrubs or small trees belonging to the genus Sapindus, which includes a number of species including, but not limited to, Sapindus delavay, Sapindus detergens, Sapindus emarginatus, Sapindus laurifolius, Sapindus marginatus, Sapindus mukorossi, Sapindus oahuensis, Sapindus rarak, Sapindus saponaria, Sapindus tomentosus, Sapindus trifoliatus, and Sapindus vitiensis.

For example, fruit from the Sapindus mukurossi tree also is known as washnut, tiha, reetha, aritha, dodan, and doadni, as well as soapberry or soapnut. The Sapindus mukurossi tree is a deciduous tree widely grown in upper reaches of Indo Gangetic plains, Shivaliks and sub Himalayan tracts at altitudes from 200 m to 1500 m. Sapindus mukurossi fruit extract has cleansing, anti-bacterial, and anti-fungal properties, among others, and it provides a less irritating alternative to non-natural chemical formulations.

In some embodiments, the bark of bush or tree from the genus Sapindus can be used, and is referred to herein as “soapbark.” In representative, non-limiting embodiments, the soapbark can be obtained from an Quillaja saponaria, or so-called “soap bark,” tree. Soap bark can impart detergency properties, as well as function as a foaming agent.

These properties have been attributed to the saponin found in soapberries and soapbark. Saponins are natural surfactants and have a diverse range of properties, including foaming, cleaning and emulsifying, pharmacological and medicinal, and haemolytic properties, as well as antimicrobial, insecticidal, spermicidal and molluscicidal activities. Saponins are amphipathic glycosides comprising one or more hydrophilic glycoside moieties combined with a lipophilic triterpene derivative. Generally, saponins are the glycosides of 27 carbon steroids or 30 carbon triterpenes.

Soapberries have been used for washing for thousands of years by native peoples and have been included, for example, in natural laundry detergents.

In further embodiments, quinoa, e.g., Chenopodium quinoa, can be substituted or used in combination with organic soapberry powder. In their natural state, quinoa seeds are coated with saponins, making them suitable for use as a detergent. Quinoa saponins can include, but are not limited to, the sapogenols, oleanolic acid, hederagenin, and phytolaccagenic acid. Accordingly, quinoa can be substituted for the organic soapberry powder in the presently disclosed compositions.

In some embodiments, the presently disclosed organic detergent powder composition comprises organic soapberry powder. In particular embodiments, the organic soapberry powder (or in some embodiments, quinoa), is provided in an amount ranging from about 0.1% to about one hundred percent (100%), including 0.1%, 0.5%, 0.75%, 1%, 1.5%, 2.0%, 2.5%, 3.0%, 3.5%, 4.0%, 4.5%, 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99%, and 100%, and any integer percentage and fraction thereof from 0.1% to 100%, depending on product function.

In some embodiments, the composition comprises from about 0.1% by weight to about 98% by weight organic soapberry powder.

In other embodiments, the composition further comprises from about 15% by weight to about 75% by weight organic soapberry powder; from about 0.1% to about 35% salt; from about 0.1% by weight to about 5% by weight of one or more detergency aids; optionally from about 0.1% by weight to about 5% by weight of one or more enzymes; and optionally from about 0.1% by weight to about 5% by weight of one or more fragrances.

In yet other embodiments, the composition further comprises from about 45% by weight to about 65% by weight organic soapberry powder; from about 30% by weight to about 50% by weight salt; from about 1% by weight to about 3% by weight of one or more detergency aids; optionally from about 0.0% by weight to about 3% by weight of one or more enzymes; and optionally from about 1% by weight of one or more fragrances.

In some embodiments, the organic soapberry powder formulation can include one or more acids. In particular embodiments, the one or more acids are selected from the group consisting of, but not limited to, NOP certified or NOP allowable citric acid, acetic acid, malic acid, L-malic acid, stearic acid, tartaric acid, ascorbic acid, alginic acid, lactic acid, phosphoric acid, muriatic acid, and combinations thereof. In particular embodiments, the presently disclosed organic detergent powder comprises from about 0.10% by weight to about 30% by weight of one or more acids, including about 0.1%, about 0.5%, about 1.0%, about 2%, about 3%, about 4%, about 5%, about 10%, about 15%, about 20%, about 25%, and about 30% by weight one or more acids.

In particular embodiments, the presently disclosed composition comprises a laundry detergent. The presently disclosed organic detergent powder can be pressed into a single-dose tablet by direct compression or also can be provided in a loose powder form. Tablets comprising the presently disclosed organic detergent powder composition can be made using any suitable equipment and method. The molds, in which tablets can be made, can have any shape, length, width and depth, depending on the required dimensions of the tablets. In further embodiments, consumer packaging of the presently disclosed composition can include silica gel or other absorbent for absorbing moisture.

D. Organic Detergent Powder Compositions Complying with the USDA National Organic Program

Importantly, the presently disclosed compositions, formulations, and/or solution are “organic.” As used herein, the term “organic” refers to a product or ingredient that complies with 7 CFR § 205.301, which establishes organic content requirements for labeling and marketing purposes. Four categories of organic content have been established by the United States Department of Agriculture (USDA) under the National Organic Program (NOP): “100 percent organic,” which is defined as products comprising 100 percent organic ingredients; “organic,” which is defined as products comprising 95 percent or more organic ingredients; “made with organic,” which is defined as products comprising between 70 percent to 95 percent organic ingredients; and “ingredient panel only,” which is defined as products comprising less than 70 percent organic ingredients.

More particularly, under 7 CFR § 205.301, all of the ingredients in products sold, labeled, or represented as “100 percent organic” must be certified organic and contain (by weight or fluid volume) 100 percent organically produced ingredients.

Products sold, labeled, or represented as “organic” must contain (by weight or fluid volume) not less than 95 percent organically produced raw or processed agricultural products. Any remaining product ingredients must be organically produced, unless not commercially available in organic form, or must be nonagricultural substances or non-organically produced agricultural products as specified on the National List under 7 CFR § 205.605. Accordingly, non-organic ingredients allowed per National List may be used, up to a combined total of five percent of non-organic content.

Products sold, labeled, or represented as “made with organic” must contain (by weight or fluid volume) at least 70 percent organically produced ingredients. Accordingly, multi-ingredient agricultural products in the “made with organic” category must include at least 70 percent certified organic ingredients. Although any remaining agricultural products are not required to be organically produced, non- agricultural products must be specifically allowed on the National List under 7 CFR § 205.605.

Multi-ingredient products having less than 70 percent certified organic content are not qualified to be certified. Accordingly, any non-certified product must not include the USDA organic seal anywhere or the word “organic” on a principal display panel. Such products may only list certified organic ingredients as organic in the ingredient list and the percentage of organic ingredients. Remaining ingredients are not required to follow the USDA organic regulations.

Further, under 7 CFR § 205.605, specified nonagricultural (nonorganic) substances may be used as ingredients in or on processed products labeled as “organic” or “made with organic,” including the following nonsynthetic and synthetic ingredients:

Nonsynthetics: acids (alginic; citric—produced by microbial fermentation of carbohydrate substances; and lactic); agar-agar; animal enzymes—(rennet—animals derived; catalase—bovine liver; animal lipase; pancreatin; pepsin; and trypsin);

bentonite; calcium carbonate; calcium chloride; calcium sulfate—mined; carrageenan; dairy cultures; diatomaceous earth—food filtering aid only; egg white lysozyme (CAS #9001-63-2); enzymes derived from edible, nontoxic plants, nonpathogenic fungi, or nonpathogenic bacteria; flavors, nonsynthetic sources only and must not be produced using synthetic solvents and carrier systems or any artificial preservative; gellan gum (CAS #71010-52-1)—high-acyl form only; glucono delta-lactone—production by the oxidation of D-glucose with bromine water is prohibited; kaolin; L-Malic acid (CAS #97-67-6); magnesium sulfate, nonsynthetic sources only; microorganisms—any food grade bacteria, fungi, and other microorganism; nitrogen—oil-free grades; oxygen- oil-free grades; perlite—for use only as a filter aid in food processing; potassium chloride; potassium iodide; sodium bicarbonate; sodium carbonate; tartaric acid—made from grape wine; waxes—nonsynthetic (Carnauba wax; and Wood resin); yeast—nonsynthetic, growth on petrochemical substrate and sulfite waste liquor is prohibited (autolysate; bakers; brewers; nutritional; and smoked—nonsynthetic smoke flavoring process must be documented); and
synthetics: activated charcoal (CAS #s 7440-44-0; 64365-11-3)—only from vegetative sources; for use only as a filtering aid; alginates; ammonium bicarbonate—for use only as a leavening agent; ammonium carbonate—for use only as a leavening agent; ascorbic acid; calcium citrate; calcium hydroxide; calcium phosphates (monobasic, dibasic, and tribasic); carbon dioxide; cellulose—for use in regenerative casings, as an anti-caking agent (non-chlorine bleached) and filtering aid; chlorine materials—disinfecting and sanitizing food contact surfaces, except that residual chlorine levels in the water shall not exceed the maximum residual disinfectant limit under the Safe Drinking Water Act (calcium hypochlorite; chlorine dioxide; and sodium hypochlorite); cyclohexylamine (CAS #108-91-8)—for use only as a boiler water additive for packaging sterilization; diethylaminoethanol (CAS #100-37-8)—for use only as a boiler water additive for packaging sterilization; ethylene—allowed for postharvest ripening of tropical fruit and degreening of citrus; ferrous sulfate—for iron enrichment or fortification of foods when required by regulation or recommended (independent organization); glycerides (mono and di)—for use only in drum drying of food; glycerin—produced by hydrolysis of fats and oils; hydrogen peroxide; lecithin—bleached; magnesium carbonate—for use only in agricultural products labeled “made with organic” prohibited in agricultural products labeled “organic”;

magnesium chloride—derived from sea water; magnesium stearate—for use only in agricultural products labeled “made with organic” prohibited in agricultural products labeled “organic”; nutrient vitamins and minerals, in accordance with 21 CFR 104; 20, Nutritional Quality Guidelines For Foods; octadecylamine (CAS #124-30-1)—for use only as a boiler water additive for packaging sterilization; ozone; pectin (low-methoxy); peracetic acid/peroxyacetic acid (CAS #79-21-0)—for use in wash and/or rinse water according to FDA limitations; for use as a sanitizer on food contact surfaces; phosphoric acid—cleaning of food-contact surfaces and equipment only; potassium acid tartrate; potassium carbonate; potassium citrate; potassium hydroxide—prohibited for use in lye peeling of fruits and vegetables except when used for peeling peaches during the Individually Quick Frozen (IQF) production process; potassium iodide—for use only in agricultural products labeled “made with organic,” prohibited in agricultural products labeled “organic”; potassium phosphate—for use only in agricultural products labeled “made with organic,” prohibited in agricultural products labeled “organic”; silicon dioxide; sodium acid pyrophosphate (CAS #7758-16-9)—for use only as a leavening agent; sodium citrate; sodium hydroxide—prohibited for use in lye peeling of fruits and vegetables; sodium phosphates—for use only in dairy foods; sulfur dioxide—for use only in wine labeled “made with organic grapes,” provided that total sulfite concentration does not exceed 100 ppm; tartaric acid—made from malic acid; tetrasodium pyrophosphate (CAS #7722-88-5)—for use only in meat analog products; tocopherols—derived from vegetable oil when rosemary extracts are not a suitable alternative; and xanthan gum.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The descriptions and specific examples that follow are only intended for the purposes of illustration, and are not to be construed as limiting in any manner to make compounds of the disclosure by other methods.

### Example 1

Certified Organic Laundry Detergent Compressed Tablet

| | Total % | Organic | Range |
|---|---|---|---|
| Ingredient | by weight | % | (% by wt) |
| Saponified | 40 | 79.94 | 0.1%-99% |
| Coconut Oil | | | |
| Sodium | 6 | 0 | 0.1%-30% |
| Carbonate | | | |
| Sodium | 13.33 | 0 | 0.1%-30% |
| Percarbonate | | | |
| Lavender | 1 | 95 | 0.1%-5% |
| Fragrance | | | |
| Protease | 2 | 0 | 0.1%-7% |
| Corn Starch | 37.67 | 100 | 0.1%-75% |
| | 100 | 70.6 | |

### Example 2

Certified Organic Automatic Dishwashing Detergent Compressed Tablet

| | Total % | Organic | Range |
|---|---|---|---|
| Ingredient | by Weight | % | (% by wt) |
| Saponified Coconut/ | 25 | 80.33 | 0.1%-99% |
| Olive Oil KCl | | | |
| Amylase | 1.5 | 0 | 0.1%-7% |
| Sodium Carbonate | 16 | 0 | 0.1%-30% |
| Sodium Percarbonate | 4 | 0 | 0.1%-30% |
| Epsom salt | 2 | 0 | 0.1%-75% |
| Lemongrass | 1 | 95 | 0.1%-5% |
| Protease | 1.5 | 0 | 0.1%-7% |
| Corn Starch | 49 | 100 | 0.1%-75% |
| | 100 | 70.03 | |

### Example 3

Certified Organic Laundry Detergent Powder (With Enzymes)

| | Total % | Organic % | Ingredient |
|---|---|---|---|
| Ingredient | weight* | weight† | Range |
| Organic | 60.75% | 95.00% | 0-15%; |
| Soapberry | | | up to 45%; |
| Powder | | | up to 70%; |
| | | | up to 100% |
| Salt | 35.00% | | salt not counted |
| | | | toward organic |
| | | | % (NOP) |
| Sodium Perborate | 1.00% | | up to 5% |
| Protease Enzyme | 0.75% | | up to 5% |
| Cellulase Enzyme | 0.75% | | up to 5% |
| Amylase Enzyme | 0.75% | | up to 5% |
| Fragrance | 1.00% | | up to 5% |

### Example 4

Certified Organic Laundry Detergent Powder (Non-Enzyme)

| | Total % | Organic % | Ingredient |
|---|---|---|---|
| Ingredient | weight* | weight† | Range |
| Organic | 50.87% | 95.01% | 0-15%; |
| Soapberry | | | up to 45%; |
| Powder | | | up to 70%; |
| | | | up to 100% |
| Salt | 45.41% | | salt not counted |
| | | | toward organic |
| | | | % (NOP) |
| Sodium | 2.72% | | up to 5% |
| Perborate | | | |
| Fragrance | 1.00% | | up to 5% |

Although the foregoing subject matter has been described in some detail by way of illustration and example for purposes of clarity of understanding, it will be understood by those skilled in the art that certain changes and modifications can be practiced within the scope of the appended claims.

That which is claimed:

1. An organic detergent composition comprising from about 0.10% by weight to about 99% by weight saponified oil; from about 0.1% by weight to about 75% by weight of one or more of a binder, filler, carrier, disintegrant, and inert ingredient; from about 0.10% by weight to about 30% by weight of one or more detergency aids; and from about 0.1% by weight to about 7% by weight of one or more enzymes; wherein the composition comprises at least one of (i) not less than 95 percent organically produced raw or processed agricultural products, or (ii) at least 70 percent certified organic ingredients.

2. The composition of claim 1, comprising from about 10% by weight to about 70% by weight saponified oil; from about 10% by weight to about 65% by weight of one or more of a binder, filler, carrier, disintegrant, and inert ingredient; from about 5% by weight to about 35% by weight of one or more detergency aids; and from about 0.5% by weight to about 5% by weight of one or more enzymes.

3. The composition of claim 1, comprising from about 30% by weight to about 50% by weight saponified oil; from about 30% by weight to about 45% by weight of one or more of a binder, filler, carrier, disintegrant, and inert ingredient; from about 15% by weight to about 25% by weight of one or more detergency aids; and from about 1% by weight to about 3% by weight of one or more enzymes.

4. The composition of claim 1, wherein the saponified oil is selected from the group consisting of coconut oil, palm (kernel or fruit) oil, corn oil, olive oil, soybean oil, sunflower oil, safflower oil, hemp oil, babassu oil, evening primrose oil, almond oil, apricot kernel oil, avocado oil, canola oil, castor oil, cocoa butter, cottonseed oil, emu oil, grapeseed oil, jojoba oil, lanolin, meadowfoam oil, lard, neem oil, shea butter, tallow, rapeseed oil, glycerin, peanut oil, vegetable oil, sesame oil, lemon oil, orange oil, grapefruit seed oil, and combinations thereof.

5. The composition of claim 1, wherein the one or more of a binder, filler, carrier, disintegrant, and inert ingredient is selected from the group consisting of alginate, agar-agar, carrageenan, gellan gum, gum Arabic, cellulose, carboxymethyl cellulose, hydroxypropylmethylcellulose , methyl cellulose, gelatin, poly(vinylpyrrolidinone), poly(ethylene glycol), guar gum, gum acacia, xanthan gum, locust bean gum, potato starch, rice starch, wheat starch, cassava starch, barley starch, oat starch, sorghum starch, sweet potato starch, rye starch, bean starch, bentonite, attapulgite, carnauba wax, wood resin, kaolin, corn starch, maltodextrin, dextrose, waxy maize starch, sugar alcohols, lecithin, tapioca starch, sorbitol, soap berry or soap berry bark powder, and combinations thereof.

6. The composition of claim 1, wherein the one or more detergency aids are selected from the group consisting of calcium carbonate, calcium sulfate, magnesium sulfate, magnesium chloride, magnesium carbonate, magnesium stearate, potassium iodide, sodium carbonate, sodium percarbonate, sodium bicarbonate, calcium citrate; potassium acid tartrate, potassium carbonate, potassium citrate, sodium citrate, potassium bicarbonate, sodium perborate, sodium gluconate, sodium sulfate, and combinations thereof.

7. The composition of claim 1, wherein the one or more enzymes are selected from the group consisting of, but not limited to, protease (Subtilisin), amylase, cellulose, lipase, mannanase, natalase, pectinase, termamyl, xyloglucanase, and the like, and combinations thereof.

8. The composition of claim 1, further comprising from about 0.10% to about 5% by weight of one or more fragrances.

9. The composition of claim 8, wherein the one or more fragrances comprise an essential oil selected from the group consisting of allspice, ambrette seed, amyris, angelica root, anise, star anise, atlas cedarwood, Peru balsam, basil, holy basil, bay, bay laurel, beeswax absolute, benzoin absolute, bergamot, bergamot mint, black pepper, blue cypress, bois-de-rose, boronia, bursera graveolens, cajeput, cananga, cardamom, carrot seed, cassia, catnip/catmint, atlas cedarwood, Virginian cedarwood, German chamomile, Roman chamomile, chocolate peppermint, cinnamon, citronella, clary sage, clove bud, coffee, common sage, coriander, cumin, cypress, blue cypress, davana, dill, dalmation sage, elemi, eucalyptus, lemon eucalyptus, radiata eucalyptus, fennel, fir needle, frankincense, galbanum, geranium, rose geranium, ginger, grapefruit, gurjum balsam, helichrysum, hyssop, immortelle, jamine absolute, juniper berry, kanuka, abrialis lavandula, lavender, lavendin, lemon, lemon balm, lemon eucalyptus, lemongrass, lemon myrtle, lime, linden blossom, mandarin, mandravasarotra, manuka, marjoram, may Chang, melissa, mullein, myrrh, myrtle, lemon myrtle, neroli, niaouli, nutmeg, oakmoss, oliganum, bitter orange, sweet orange, oregano, palmarosa, palo santo, parsley, patchouli, peppermint, petitgrain, berry/leaf pimento, scotch pine, ravensara, rose, rosemary, rosewood, common sage, Spanish sage, sandalwood, saro, spearmint, spikenard, spruce, tagetes, tangerine, common tea tree, lemon tea tree, New Zealand tea tree, thyme, tobacco, tuberose, tulsi, vanilla, vetiver, violet leaf, yarrow, ylang ylang, and yuzu.

10. The composition of claim 1, further comprising from about 0.1% by weight to about 75% by weight salt or water softener.

11. The composition of claim 10, wherein the salt or water softener is selected from the group consisting of sodium chloride, potassium chloride, calcium chloride, sea salt, table salt, celery salt, curing salt, dairy salt flake salt, fleur de sel, garlic salt, kosher salt, himalayan salt, jukyeom, kala namak, LoSalt, pickling salt, truffle salt, and combinations thereof.

12. The composition of claim 1, further comprising from about 0.1% by weight to about 30% by weight lye.

13. The composition of claim 12, wherein the lye is selected from the group consisting of sodium hydroxide, potassium hydroxide, calcium hydroxide, and combinations thereof.

14. The composition of claim 1, further comprising from about from about 0.1% by weight to about 30% by weight of one or more defoamers or flow agents.

15. The composition of claim 14, wherein the one or more defoamers or flow agents are selected from the group consisting of silica, sodium silicate and its derivatives, talc, bentonite, and combinations thereof.

16. The composition of claim 14, wherein the flow agent-is selected from the group consisting of cellulose gum, carboxymethyl cellulose/carboxymethyl hydroxyethyl cellulose (CMC/CMHEC), guar gum, gellan gum, bovine bone gelatin, acacia gum, xanthan gum, cassia gum, hydroxy ethyl cellulose, glycerin, sodium carboxymethyl cellulose, and modified starch.

17. The composition of claim 1, further comprising from about from about 0.10% by weight to about 10% by weight chelating agents.

18. The composition of claim 17, wherein the one or more chelating agents are selected from the group consisting of, but not limited to, delta glucolactone, gluconic acid, sodium gluconate, ethylenediaminetetraacetic acid, and triethanolamine.

19. A single-dose compressed tablet comprising the composition of claim 1.

20. A laundry detergent comprising the composition of claim 1.

21. An organic detergent composition comprising from about 0.10% by weight to about 99% weight saponified oil; from about 0.1% by weight to about 75% by weight of one or more of a binder, filler, carrier, disintegrant, and inert ingredient; from about 0.10% by weight to about 30% by weight of one or more detergency aids; from about 0.1% by weight to about 7% by weight of one or more enzymes; and from about 0.1% by weight to about 75% by weight salt or water softener;
wherein the composition comprises at least one of (i) not less than 95 percent organically produced raw or processed agricultural products, or (ii) at least 70 percent certified organic ingredients.

22. The composition of claim 21, comprising from about 5% by weight to about 45% weight saponified oil; from about 15% by weight to about 75% by weight of one or more of a binder, filler, carrier, disintegrant, and inert ingredient; from about 0.5% by weight to about 35% by weight of one or more detergency aids; from about 0.5% by weight to about 5% by weight of one or more enzymes; and from about 0.5% by weight to about 5% by weight salt or water softener.

23. The composition of claim 21, comprising from about 15% by weight to about 35% weight saponified oil; from about 35% by weight to about 65% by weight of one or more of a binder, filler, carrier, disintegrant, and inert ingredient; from about 15% by weight to about 25% by weight of one or more detergency aids; from about 2% by weight to about 4% by weight of one or more enzymes; and from about 1% by weight to about 3% by weight salt or water softener.

24. The composition of claim 21, wherein the saponified oil is selected from the group consisting of coconut oil, palm (kernel or fruit) oil, corn oil, olive oil, soybean oil, sunflower oil, safflower oil, hemp oil, babassu oil, evening primrose oil, almond oil, apricot kernel oil, avocado oil, canola oil, castor oil, cocoa butter, cottonseed oil, emu oil, grapeseed oil, jojoba oil, lanolin, meadowfoam oil, lard, neem oil, shea butter, tallow, rapeseed oil, glycerin, peanut oil, vegetable oil, sesame oil, lemon oil, orange oil, grapefruit seed oil, and combinations thereof.

25. The composition of claim 21, wherein the one or more of a binder, filler, carrier, disintegrant, and inert ingredient is selected from the group consisting of alginate, agar-agar, carrageenan, gellan gum, gum Arabic, cellulose, carboxymethyl cellulose, hydroxypropylmethylcellulose , methyl cellulose, gelatin, poly(vinylpyrrolidinone), poly(ethylene glycol), guar gum, gum acacia, xanthan gum, locust bean gum, potato starch, rice starch, wheat starch, cassava starch, barley starch, oat starch, sorghum starch, sweet potato starch, rye starch, bean starch, bentonite, attapulgite, carnauba wax, wood resin, kaolin, corn starch, maltodextrin, dextrose, waxy maize starch, sugar alcohols, lecithin, tapioca starch, sorbitol, soap berry or soap berry bark powder, and combinations thereof.

26. The composition of claim 21, wherein the one or more detergency aids are selected from the group consisting of calcium carbonate, calcium sulfate, magnesium sulfate, magnesium chloride, magnesium carbonate, magnesium stearate, potassium iodide, sodium carbonate, sodium percarbonate, sodium bicarbonate, calcium citrate; potassium acid tartrate, potassium carbonate, potassium citrate, sodium citrate, potassium bicarbonate, sodium perborate, sodium gluconate, sodium sulfate, and combinations thereof.

27. The composition of claim 21, wherein the one or more enzymes are selected from the group consisting of, but not limited to, protease (Subtilisin), amylase, cellulose, lipase, mannanase, natalase, pectinase, termamyl, xyloglucanase, and the like, and combinations thereof.

28. The composition of claim 21, wherein the salt or water softener is selected from the group consisting of sodium chloride, potassium chloride, calcium chloride, sea salt, table salt, celery salt, curing salt, dairy salt flake salt, fleur de sel, garlic salt, kosher salt, himalayan salt, jukyeom, kala namak, LoSalt, pickling salt, truffle salt, and combinations thereof.

29. The composition of claim 21, further comprising from about 0.10% to about 5% by weight of one or more fragrances.

30. The composition of claim 29, wherein the one or more fragrances comprise an essential oil selected from the group consisting of allspice, ambrette seed, amyris, angelica root, anise, star anise, atlas cedarwood, Peru balsam, basil, holy basil, bay, bay laurel, beeswax absolute, benzoin absolute, bergamot, bergamot mint, black pepper, blue cypress, bois-de-rose, boronia, bursera graveolens, cajeput, cananga, cardamom, carrot seed, cassia, catnip/catmint, atlas cedarwood, Virginian cedarwood, German chamomile, Roman chamomile, chocolate peppermint, cinnamon, citronella, clary sage, clove bud, coffee, common sage, coriander, cumin, cypress, blue cypress, davana, dill, dalmation sage, elemi, eucalyptus, lemon eucalyptus, radiata eucalyptus, fennel, fir needle, frankincense, galbanum, geranium, rose geranium, ginger, grapefruit, gurjum balsam, helichrysum, hyssop, immortelle, jamine absolute, juniper berry, kanuka, abrialis lavandula, lavender, lavendin, lemon, lemon balm, lemon eucalyptus, lemongrass, lemon myrtle, lime, linden blossom, mandarin, mandravasarotra, manuka, marjoram, may chang, melissa, mullein, myrrh, myrtle, lemon myrtle, neroli, niaouli, nutmeg, oakmoss, oliganum, bitter orange, sweet orange, oregano, palmarosa, palo santo, parsley, patchouli, peppermint, petitgrain, berry/leaf pimento, scotch pine, ravensara, rose, rosemary, rosewood, common sage, Spanish sage, sandalwood, saro, spearmint, spikenard, spruce, tagetes, tangerine, common tea tree, lemon tea tree, New Zealand tea tree, thyme, tobacco, tuberose, tulsi, vanilla, vetiver, violet leaf, yarrow, ylang ylang, and yuzu.

31. The composition of claim 21, further comprising from about 0.1% by weight to about 30% by weight lye.

32. The composition of claim 31, wherein the lye is selected from the group consisting of sodium hydroxide, potassium hydroxide, calcium hydroxide, and combinations thereof.

33. The composition of claim 21, further comprising from about from about 0.1% by weight to about 30% by weight of one or more defoamers or flow agents.

34. The composition of claim 33, wherein the one or more defoamers or flow agents are selected from the group consisting of silica, sodium silicate and its derivatives, talc, bentonite, and combinations thereof.

35. The composition of claim 33, wherein the flow agent-is selected from the group consisting of cellulose gum, carboxymethyl cellulose/carboxymethyl hydroxyethyl cellulose (CMC/CMHEC), guar gum, gellan gum, bovine bone gelatin, acacia gum, xanthan gum, cassia gum, hydroxy ethyl cellulose, glycerin, sodium carboxymethyl cellulose, and modified starch.

36. The composition of claim 21, further comprising from about from about 0.10% by weight to about 10% by weight chelating agents.

37. The composition of claim 36, wherein the one or more chelating agents are selected from the group consisting of, but not limited to, delta glucolactone, gluconic acid, sodium gluconate, ethylenediaminetetraacetic acid, and triethanolamine.

38. A single-dose compressed tablet comprising the composition of claim 21.

39. An automatic dish detergent comprising the composition of claim 21.

40. An organic detergent composition comprising from about 0.1% by weight to about 98% by weight organic soapberry powder.

41. The composition of claim 40, further comprising from about 15% by weight to about 75% by weight organic soapberry powder; from about 0.1% to about 35% salt; from about 0.1% by weight to about 5% by weight of one or more detergency aids; optionally from about 0.1% by weight to about 5% by weight of one or more enzymes; and optionally from about 0.1% by weight to about 5% by weight of one or more fragrances.

42. The composition of claim 40, further comprising from about 45% by weight to about 65% by weight organic soapberry powder; from about 30% by weight to about 50% by weight salt; from about 1% by weight to about 3% by weight of one or more detergency aids; optionally from about 0.0% by weight to about 3% by weight of one or more enzymes; and optionally from about 1% by weight of one or more fragrances.

43. A compressed single-dose tablet comprising the composition of claim 40.

44. A laundry detergent comprising a composition of claim 40.
